(19) United States
(12) Patent Application Publication
(10) Pub. No.: US 2002/0114376 A1
(43) Pub. Date: Aug. 22, 2002

(54) Surface contact clinical thermometer

(75) Inventor: Chu-Yih Yu, Chung City (TW)

Correspondence Address: DOUGHERTY & TROXELL, Suite 1404, 5205 Leesburg Pike, Falls Church, VA, 22041, US

(73) Assignee: Mesure Technology Co., Ltd.

(21) Appl. No.: 09/788,378

(22) Filed: Feb. 21, 2001

(51) Int. Cl. G01K 1/08

(52) U.S. Cl. 374/158; 600/549; 374/120

(57) ABSTRACT

A surface contact clinical thermometer having a flexible press member protruded from the outside wall of the body thereof, and an induction chip mounted in the flexible press member in flush with the surface of the flexible press member for contacting the body skin of a person to detect the body temperature of the person.

### BACKGROUND OF THE INVENTION

The present invention relates to a clinical thermometer and, more particularly to the surface contact clinical thermometer, which is safe and comfortable in use.

A variety of mechanical and electronic thermometers have been disclosed, and have appeared on the market. Regular electronic thermometers, for example, infrared thermometers are convenient in use. However, an infrared ray tends to be affected by external substances, resulting in an accurate detection result. Further, regular mechanical clinical thermometers are dangerous in use. When the child is crying and cannot be calmed down, the accuracy of the body temperature detection may be affected.

### SUMMARY OF THE INVENTION

The present invention has been accomplished under the circumstances in view. It is one object of the present invention to provide a clinical thermometer, which is safe in use. It is another object of the present invention to provide a clinical thermometer, which is comfortable in use. To achieve these and other objects of the present invention, the surface contact clinical thermometer comprises a flexible press member protruded from the outside wall of the body thereof, and an induction chip mounted in the flexible press member in flush with the surface of the flexible press member for contacting the body skin of a person to detect the body temperature of the person. The flexible press member can be provided at the top sidewall of the body near its front side, or directly installed in the front end of the body.

### BRIEF DESCRIPTION OF THE DRAWINGS

FIG. 1 is an elevational view of a surface contact clinical thermometer according to the present invention.

FIG. 2 is a sectional view taken along line 2-2 of FIG. 1.

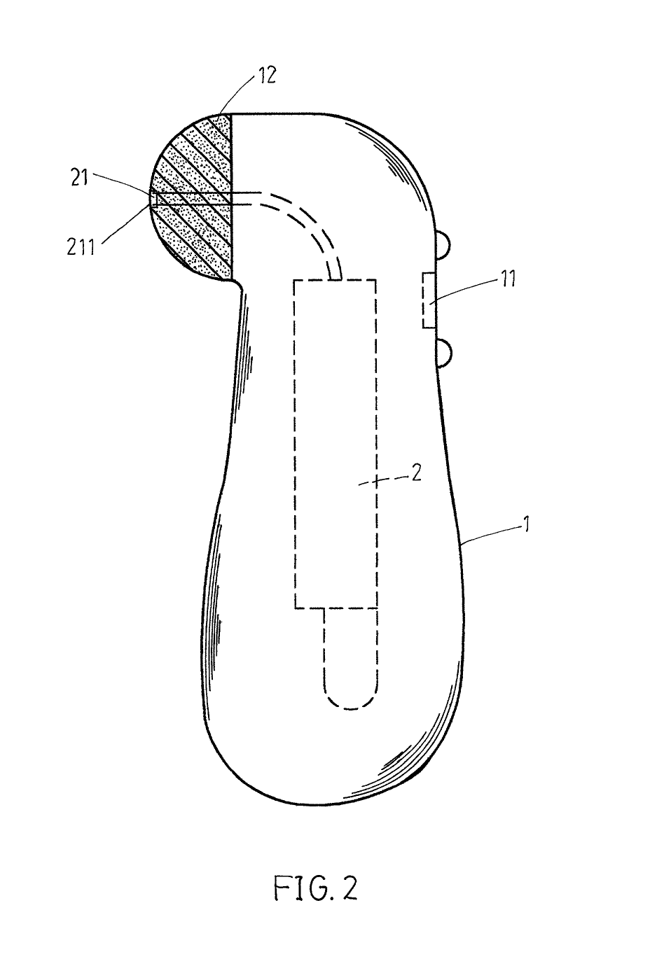

FIG. 3 is a schematic drawing showing the flexible press member pressed on the body skin according to the present invention.

FIG. 4 is a sectional view of an alternate form of the flexible press member according to the present invention.

FIG. 5 is a schematic drawing showing the flexible press member of the alternate form of the present invention pressed on the body skin.

FIG. 6 illustrates a surface contact clinical thermometer according to a second embodiment of the present invention.

### DETAILED DESCRIPTION OF THE PREFERRED EMBODIMENT

Referring to FIGS. from 1 through 3, a surface contact clinical thermometer in accordance with the present invention comprises a body 1 having a display window 11, a circuit board 2 mounted inside the body 1, and a switch and an indicator light (not shown) on the outside of the body 1. A press member 12 is provided at the top sidewall of the body 1 near its front side. The press member 12 is made of springy, flexible material. An induction chip 21 is mounted in the press member 12 and electrically connected to the circuit board 2. The induction chip 21 has a detecting face 211 covered with a protective membrane 21 and disposed in flush with the outer surface of the press member 12.

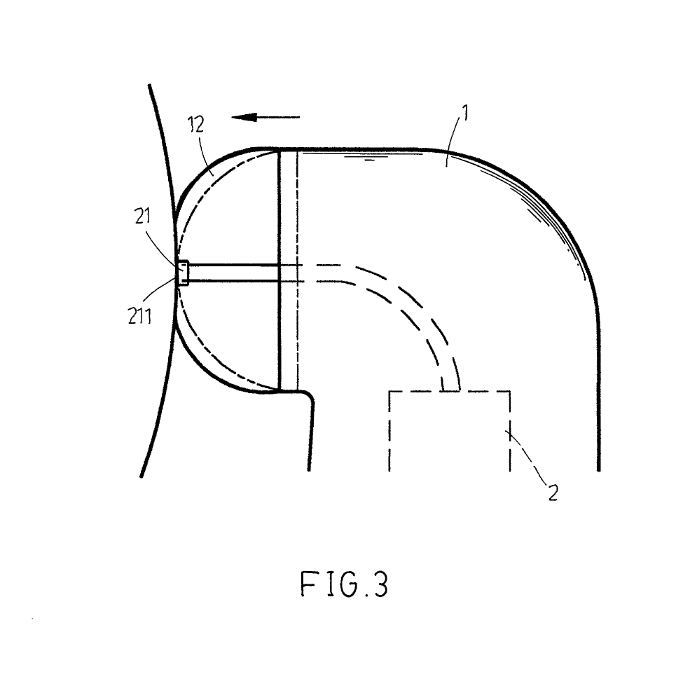

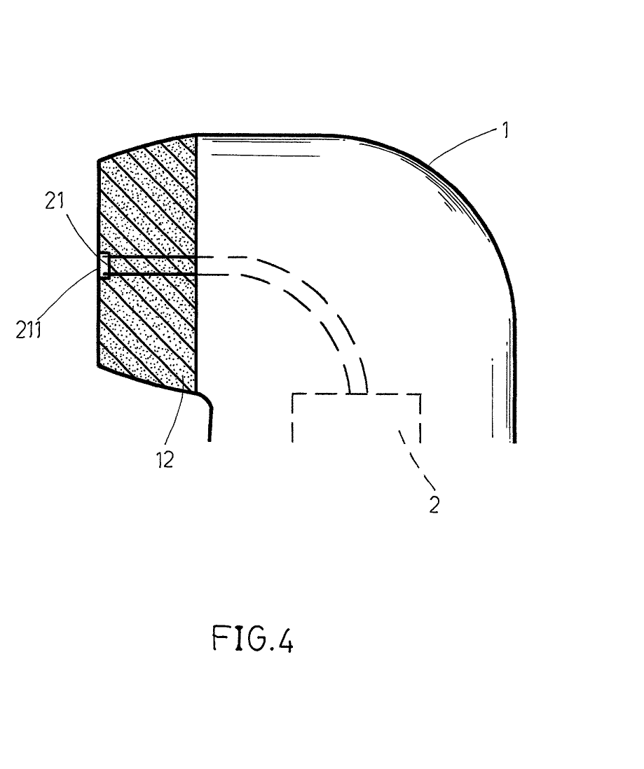

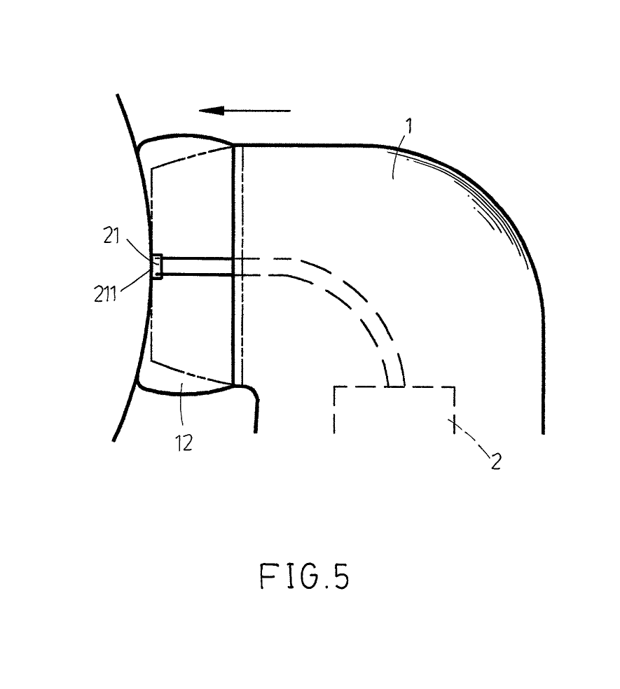

Referring to FIGS. 4 and 5 and FIG. 3 again, the press member 12 can be shaped like a hemispherical shell as shown in FIG. 3, or shaped like a truncated cone as shown in FIGS. 4 and 5. When attaching the press member 12 to body skin to force the induction chip 21 into contact with the body skin, a part of the pressure from the induction chip 21 in perpendicular direction relative to the body skin is distributed through the press member 12, therefore the baby or person been measured does not feel pain.

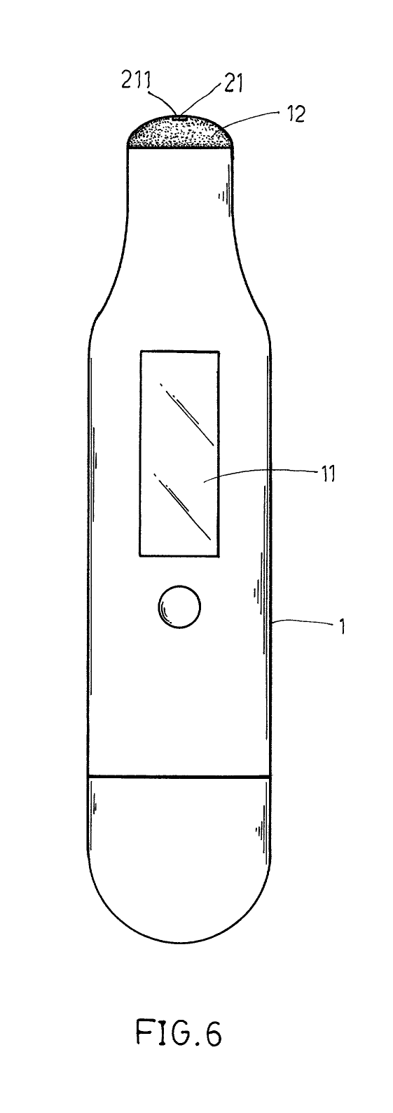

Referring to FIG. 6, the induction chip 21 and the press member 12 may be provided at the front end of the body 1.

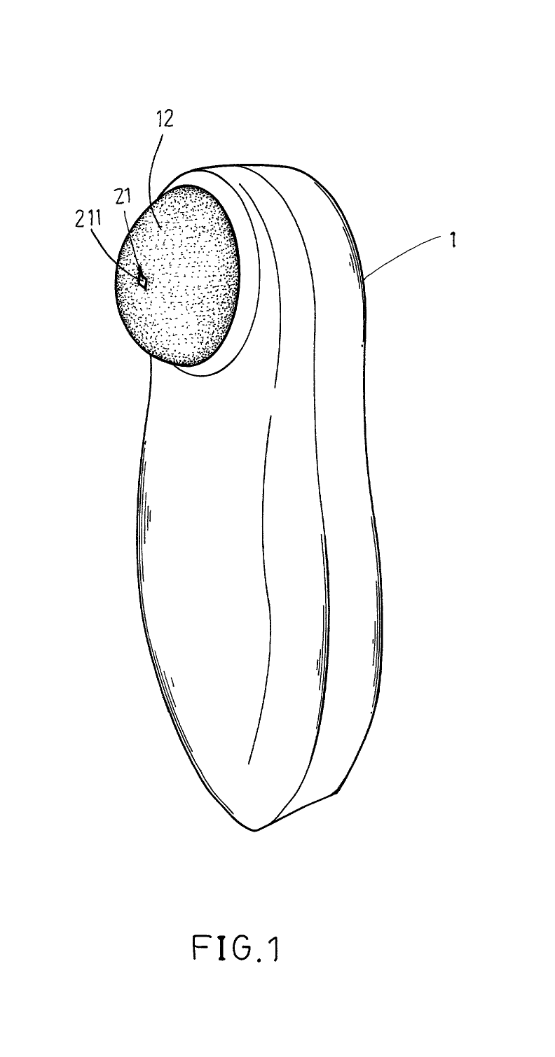

A prototype of surface contact clinical thermometer has been constructed with the features of FIGS. 1˜6. The surface contact clinical thermometer functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A surface contact clinical thermometer comprising a flexible press member fixedly provided on the outside of a body thereof and an induction chip mounted in said flexible press member in flush with the surface of said flexible press member for contacting the body skin of a person to detect the body temperature of the person.

2. The surface contact clinical thermometer of claim 1 wherein said flexible press member has a smoothly arched surface protruded from said body.

3. The surface contact clinical thermometer of claim 1 wherein said flexible press member is shaped like a truncated cone.

4. The surface contact clinical thermometer of claim 1 wherein said induction chip is covered with a protective membrane.
